(19) United States
(12) Patent Application Publication
(10) Pub. No.: US 2021/0362296 A1
(43) Pub. Date: Nov. 25, 2021

(54) TRUING DEVICE FOR CIRCULAR TOOLS AND METHOD FOR MOUNTING/REMOVING CIRCULAR TOOLS

(71) Applicant: Ronny Willian KÖNNEMANN, Frankfurt am Main (DE)

(72) Inventor: Ronny Willian KÖNNEMANN, Frankfurt am Main (DE)

(21) Appl. No.: 17/256,473

(22) PCT Filed: Jun. 27, 2018
(86) PCT No.: PCT/DE2018/100592

§ 371 Date: Dec. 28, 2020

(51) Int. Cl. B24B 53/14

(52) U.S. Cl. CPC B24B 53/14

(57) ABSTRACT

A truing device includes a housing and a truing mandrel (1) with a shaft (10) used to mount a circular tool having a concentric opening, in particular a grinding disc (3), and with a first bearing (11) fixed on the housing (4) and located in a first end region of the truing mandrel (1) The shaft (10) includes a hydraulic clamping device (20) having a chamber (21) containing hydraulic medium, to which a pre-clamping pressure can be applied with a preclamping element (23) The hydraulic clamping device is formed from a clamping section (22) lying above the chamber (21) in the radial direction and held in the shaft on both sides. The outer surface of the clamping section forms the clamping surface and which, when the hydraulic pressure in the chamber (21) increases, can be reversibly moved or bent outwards in the radial direction such that a radial clamping force can be exerted on the inner surface of the concentric opening of the circular tool penetrated by the clamping section (22). A method provides for mounting and removing a circular tool on the truing mandrel of a truing device of this kind.

The present invention relates to a dressing device, comprising a housing, and a dressing mandrel having a shaft, which serves for the installation of a circular tool with a through-passing concentric opening, in particular a grinding disk, and a first bearing, which is fixed on the housing and is located in a first end region of the dressing mandrel, and a dressing tool for dressing the circular tool which is mounted on the dressing mandrel, the shaft having a hydraulic clamping device, which passes through the opening in the circular tool and comprising a chamber with a hydraulic medium, which can be subjected to a preclamping pressure by means of a preclamping element.

In material machining, circular tools are used, which are clamped on the shaft of a machine tool and set into rapid rotation in contact with a workpiece that is to be machined. In order to machine the outer form or the surface of a workpiece, in particular constant shaped or profiled grinding disks are used.

Despite the use of grinding disks that are as abrasion-resistant and resilient as possible, frequent improvement of the grinding tool, so-called dressing, is necessary, particularly in the case of high-precision applications, to retain the necessary accuracy and precision of the cutting.

To this end, the grinding disk is removed from the machine tool and inserted into a dressing machine or dressing device. As in the prior art, these consist of a housing, a dressing tool, the profile of which represents a negative of the desired profile of the grinding disk, and a dressing mandrel, which in turn serves to receive the grinding disk to be dressed.

The dressing tool and the grinding disk to be dressed are then accelerated to a high rotational speed and brought into contact with the grinding surfaces, so that the grinding tool itself is ground by the harder dressing tool and is restored to its desired profile.

To receive the tool to be dressed, the dressing mandrel comprises a section for connection of a drive motor by means of a coupling or a belt and an interposed first or main bearing, the dressing mandrel, at least at the first bearing, being fixed on the housing. Furthermore, seen from the first bearing, beyond the grinding disk receptacle, the dressing mandrel can have a second bearing, with which it is also fixed on the housing. By damping axial and radial vibrations, this fixing of the dressing mandrel at both sides greatly improves the concentricity and axial run-out of the grinding disk, particularly at high speeds and under high mechanical loading of the grinding disk during dressing.

The dressing tool has the demanding task of restoring the profile of a circular tool made of a hard material, in particular a grinding disk, with micrometre accuracy, so that this circular tool can continue to be used. To satisfy these accuracy requirements, it is necessary to use an even harder material that that of the circular tool, at least for the surface of the dressing tool. If a high dressing accuracy is achieved by means of a durable and precise dressing tool, this is continued into the workpiece.

To satisfy the requirements of a profile accuracy at a micrometre scale, however, it is also absolutely necessary for the grinding disk to be positioned on the dressing mandrel with corresponding accuracy and also not to change under the influence of the high forces that naturally act on the grinding disk during dressing. This requires an absolutely stable and completely backlash-free fit of the grinding disk both in the radial and in the axial direction. This cannot be achieved by means of mechanical clamping devices, such as those known from machine tools.

On the contrary, the solution practised in the prior art provides for the grinding disks to be “shrunk” onto the dressing mandrel by thermal treatment, that is to say the disk, at a higher temperature than the mandrel, is mounted or pushed onto the latter. Due to the difference in the thermally induced change in size of the two parts, the necessary firm seating is achieved during the subsequent temperature equalization.

The problem here is the time consumption and complexity of this process, both during mounting of the grinding disk before dressing as well as, in particular, taking off after dressing. The latter process, alone, usually takes several hours.

In addition, due to the intensive contact of the two parts during taking off, it is not possible to achieve such a high temperature difference as during mounting and therefore also to achieve an adequate size difference for a mechanically simple taking off. This means that during taking off of the grinding disk from the dressing mandrel, significantly larger forces must be applied than during putting on. In this, there is always the risk of damaging one or both part parts, which not only destroys the dressing success but requires the procurement of a new grinding disk, a new dressing mandrel or both.

It would thus be desirable to achieve the required firm fit of the tool on the dressing mandrel in a way that permits rapid and risk-free mount and taking off.

In the field of machine tools, clamping devices are known that work with hydraulic components. Thus, patent DE 2 333 762 B2 describes a clamping device having a pressure chamber that concentrically surrounds the spindle or shaft, with an elastically deformable outer wall, the outer surface of which forms the clamping face. The disadvantage of this is that this clamping device is integrated into the tool itself, that is to say requires a special and complicated design of each individual tool.

By contrast with this, DE 88 13 580 U1 proposes a clamping device which comprises a hydraulically widenable clamping part in the form of a clamping bush with internal hydraulic medium chamber. This chamber can be filled with hydraulic medium via a bore, which is sealed with a clamping screw, the pressure being adjustable by means of the clamping screw. The axial fixing and positioning of the tool is ensured by means of an axial clamping member, which is connected in an axial direction to the tool to be clamped.

Although in this case the clamping device is integrated into the spindle, the disadvantage remains that positioning is only possible in the end region of the spindle and it therefore cannot be used with spindles or dressing mandrels that are fixed at both sides.

Against this background, it is the object of the present invention to provide a dressing machine for receiving tools, in particular a grinding disk, with a dressing mandrel, which is of simple design and nevertheless permits a robust and quickly releasable fastening of the tools, even if it is supported at both sides of the tool.

This object is achieved according to the invention by means of a dressing device according to claim 1, which comprises a dressing mandrel, which permits quick and simple mounting and taking off of a grinding disk according to the subordinate claims 14 and 15.

A characteristic of the present invention is that the clamping section is held on both sides, that is to say it is held in the shaft at both the side facing toward the first bearing and at the side facing away from it. How this is actually realized is not material within the scope of the present invention as long as a fastening at both sides is ensured that is essentially equally load-bearing.

By this means it is advantageously achieved that the elastic deformation of the clamping section, which is produced as a result of a pressure increase of the hydraulic medium, or the clamping force exerted on the inner surface of a through-opening of a circular tool in axial profile is significantly more uniform than in the case of the known clamping devices, which use a clamping bush that is held at one side and is non axially symmetrical.

This advantage is further reinforced if the clamping section is designed such that its cross-section remains unchanged in its axial profile (continuous translational symmetry) or repeats periodically (discrete translational symmetry), since this requires a uniform elastic bulging/deformation of the clamping section and/or a uniform transfer of the clamping force from the clamping section to the clamping face of the circular tool bearing thereon (that is to say the inner surface of the opening of the tool through which the dressing mandrel passes).

It is particularly advantageous in the solution provided by the present invention, of providing a clamping section that is held at both sides, that, in contrast to the clamping devices known in the prior art, it is also compatible with a bearing of the dressing mandrel at both sides. This is preferred over a bearing at one side because, here, undesirable oscillations are highly dampened and in addition both by the fact of the bearing at both sides as well as additionally through a suitable choice of the pre-stressing and strike angles of the bearings used, the natural frequencies can be detuned such that the relevant resonances are not close to the frequencies found in practical operation.

The connection to the shaft, according to the invention, at both sides, could be executed by the clamping section on one or on both sides such that it is integral with the shaft. This can either be achieved in that, from a cylindrical, usually metal, blank, only as much material is removed as is necessary to form the hydraulic medium chamber. The clamping section them remains behind as an integral component. Since, however, accessibility of the chamber for machining is presupposed thereby, this only comes into consideration in the case of an integral connection between the clamping section and shaft at one side.

If an integral connection at both sides is to be achieved, only casting processes currently come into consideration. Here, the hydraulic chamber and all further cavities of the shaft or dressing mandrel (without bearing) are determined by a sufficiently temperature-resistant positive, the exterior dimensions of the shaft/mandrel by a corresponding negative. To remove the hydraulic chamber and the further positive(s) filling out the cavities, after cooling of the casting material, they must be made flowable. For this purpose, for example, chemical processes such as etching or mechanical processes such as vibration or ultrasonic waves are used.

An interesting alternative also consists in forming the positive of the hydraulic medium chamber from the hydraulic fluid that is subsequently used and which, before casting, is cryogenically cooled as far as necessary, for example to 80 kelvin or even lower. If the casting material is rapidly filled with a lowest possible temperature, a premature liquefaction or evaporation of the medium and thereby a disadvantageous change of the chamber form is avoided or reduced.

Furthermore, additive manufacturing (3D printing) could also be used to easily manufacture a shaft with an integral clamping section at both sides and a chamber according to the present invention below it. The problem with this is that 3D printing of a material with high mechanical strength, as required by the shaft of a dressing mandrel by virtue of the occurring clamping and rotational forces, ist currently still difficult.

An integral connection at both sides would also be achieved if, after the hydraulic medium chamber has been introduced into a blank by a suitable method, it is full-surface sealed in a pressure-tight manner by means of a planar material piece. If the hydraulic chamber has, for example, a circular cross-section that is uniform in its axial extension, then an initially rectangular material piece can be used, which is wound onto the blank such that it upwardly seals the chamber, so that in the end state it forms a hollow cylinder. A firm, durable and pressure-resistant connection can be produced by adhesive bonding or, with a suitable choice of material, also by welding, for example thermal or else electromagnetic pulse welding.

Alternatively, connection of the clamping section to the shaft may also be non-integral on one or both sides, in the latter case, the clamping section forming a clamping bush. In order to ensure the necessary pressure tightness here, it is recommended that the end of the clamping section in each case be designed in the manner of a full, inward-facing flange, so that, under the effect of the pressurized hydraulic medium in the chamber, it areally conforms at one end face to a shoulder of the shaft. In order to avoid leaks, an annular seal of a suitable elastic material can be inserted between the clamping section end face and the shaft shoulder. Alternatively or additionally, the inner rim of the inwardly facing deflection can in turn be outwardly bent, so that, in the longitudinal section, there is an offset and, in three dimensions, a hollow cylinder with step is present. If the clamping section is connected to the shaft, the comparatively short, hollow-cylindrical part with the smaller diameter engages in a surrounding notch of the shaft shoulder.

If the clamping section is at both sides, that is to say is formed at its upper and lower end as described, it would then be difficult or even impossible to insert, in the case of a one-part shaft. It is therefore proposed in this case to design the shaft in two parts, the subdivision taking place in the region of the chamber. This allows the clamping section to be first inserted into one of the parts and then the second shaft part to be attached.

According to the method of the present invention, the pulling off of a circular tool, in particular a grinding disk, takes place in two to four steps. First the dressing mandrel, if appropriate, that is to say depending on the design of the housing and of the mandrel, is to be released at at least one end from its fixing in the housing of the dressing machine in order to gain access to the circular tool. Even easier access can be achieved if all, that is to say in particular fixing of the mandrel at both sides is released and the mandrel is completely removed from the housing. To this end, the housing is constructed from separable, in particular halves that fold open. In the second step, an axial fixing, independent of the preclamping element, which may be present, is released. In the third step, with the aid of the pre-stressing element, the pressure of the hydraulic medium is reduced to such an extent that the gripping force is sufficiently reduced, in particular substantially nullified. Then the circular tool is taken off the shaft and thereby off the dressing mandrel and removed. The dressing mandrel is now ready to receive a further circular tool to be dressed.

The mounting is performed in a similar manner, except using the preclamping element in reverse order in four to seven steps. If one again starts from a mandrel used in the dressing machine according to the invention, then its fixing(s) on the housing first have to be released again and the mandrel released if necessary. An axial fixing independent of the preclamping element then has to be opened. Subsequently, if necessary by means of the preclamping element, for example by bringing it into a relaxation position, the pressure of the hydraulic medium and thereby the diameter of the clamping section is reduced to such an extent that it is at least no larger than the clear width of a continuous opening of the circular tool. In the next step, the latter is pushed onto the dressing mandrel. Subsequently the hydraulic medium pressure is increased by means of the preclamping element to the extent that, by expansion of the clamping section, a radial clamping force of the desired magnitude is exerted on the circular tool. An axial fixing means, which may be present, is mounted again and subsequently the dressing mandrel together with the mounted, clamped-in circular tool is inserted into the housing again or fixed in the housing, the drive side of the mandrel also being brought into operative connection with the drive, for example coupled to the shaft of a motor or encircled by a drive belt.

Mounting as well as taking off only take a few seconds, up to ten seconds for a dressing mandrel according to the invention, which contrasts with the thermal process used in the prior art, in which taking off, especially, takes up to several hours. Nevertheless, precision and accuracy of positioning in the micrometre to sub-micrometre range are achieved.

Advantageous further developments of the present invention are presented below, which can be realised individually or, insofar as they are not obviously mutually exclusive, in combination.

To meet the accuracy requirements in the micrometer range during dressing of the circular tool that is mounted on the dressing mandrel of the dressing device according to the invention, it is proposed to execute the dressing tool of the dressing device as a diamond roll, that is to say as a form roll that is inlaid or coated with diamonds on its surface. Herein, the greater the precision of this diamond roll, the higher is also the precision of the grinding disk, which is in turn transferred to the workpiece. Furthermore, the dressing operation can be performed faster with diamond rolls than with dressing tools of other materials, wherein they nevertheless have a long lifetime and a higher degree of repeatability is guaranteed.

In an embodiment proposed by the present invention, the clamping section is executed as a comparatively thin hollow cylinder, which is integrally connected to the shaft at both sides. This connection can be achieved by forming the hydraulic medium chambers and thereby the clamping section from one piece when manufacturing the mandrel. Alternatively, they can also be first produced separately from one another and then joined by means of suitable methods, such as bonding or welding. The radial thickness or strength of the clamping section herein is a compromise between two opposing requirements: on the one hand, the elastic modulus of the section is reduced due to a lower strength and thereby its deformability under a pressure increase is improved, on the other hand, however, its stability and robustness toward punctiform forces at low hydraulic pressure are also reduced. The latter can in particular lead to an undesired sensitivity to careless handling during mounting or taking off of the circular tool which is to be dressed or has been dressed. However, too great a thickness disadvantageously increases the hydraulic pressure necessary for a particular clamping effect. In the case of a dressing mandrel of raised steel, thicknesses of 0.2-2 mm, preferably 0.4-1 mm, have proved suitable.

For a further improvement of the robustness with the greatest possible elasticity, the thickness of the clamping section may also have a circumferential and/or axial variation. The floor or the ceiling of the hydraulic chamber, or both, can have supporting structures, which extend almost as far as the opposite side in each case and thus prevent excessive deformation of the clamping section under the effect of external forces. In particular a circumferentially and/or axially undulating profile, the undulation amplitude being almost the height, that is to say the maximum radial extension of the hydraulic medium chamber, is proposed. In the case of local loading that exceeds the hydraulic pressure, an excessively large, possibly destructive deformation can be avoided because in this case the underside of the undulations touch down on the base of the chamber and thus dissipate the force into the lower-lying structure of the shaft.

A greater robustness can also be achieved by subdividing the hydraulic chambers circumferentially or else in an axial direction into a plurality of rotationally symmetrical or uniform subchambers. The partition walls located between the chambers help in the dissipation of local or else areal forces from the surface of the clamping section into the lower structure and thereby increase the resistance considerably.

In an embodiment of the present invention, clamping bodies that are supported so as to be radially displaceable are provided for additional pressure generation and/or transmission. They are radially displaceable, and only need to be so to a limited extent; a movement tolerance of several per mill to several percent of the shaft outer radius is generally sufficient. This tolerance is measured between a lower stop as far as an upper stop. However, it should preferably be dimensioned so large that an expansion of the circular tool due to the rapid rotation during dressing and the resulting enlargement of the radius of the clamping opening of the tool can be compensated. The required radial movement tolerance thus depends on the extensibility, that is to say the modulus of elasticity of the circular tool to be dressed.

The clamping bodies can be designed as, in particular mirror-symmetrical, cylindrical ring segments or be based on such, at least in shape.

They can be disposed radially below the hydraulic chamber. This offers the advantage that a radial force exerted due to the radial movement of the clamping bodies is uniformly distributed areally due to the hydraulic medium. This is in particular helpful or necessary if the clamping bodies do not cover the full circumference of the shaft or clamping section but axially-radially oriented partition walls with a more or less large angular diameter are provided between them. Such subdivisions can serve for the greater resilience of the shaft with respect to the flexural moments, which can be caused by the unilateral radial and/or axial forces during dressing on the rotating circular tool, which is clamped on the mandrel (specifically when these forces are applied asymmetrically).

However, embodiments are also conceivable in which partition walls or circumferential subdivisions between individual or all clamping bodies are not used. In these cases, although a thicker bending under the described forces must be taken into account, the uniform distribution of radial forces exerted by the clamping bodies is improved.

Such radial forces due to the clamping bodies can be subdivided into two types: static and dynamic forces. Static forces can be generated in that a radially outwardly directed force is exerted on the clamping bodies either with mechanical or, again, hydraulic means. Dynamic forces are exerted by the clamping bodies during rotation of the dressing mandrel, due to their centrifugal forces. These are proportional to the square of the rotational frequency and proportional to the radius and to the mass of the clamping bodies. The dynamic component of the clamping or gripping force, which can be maximally exerted by the clamping bodies results from the product of the square of the rotational angle frequency, the mean radius of the clamping body (that is to say the average distance from the axis of rotation) and the areal density of the clamping body. The latter in turn results from the spatial density multiplied by the radial extension of the clamping body.

The present invention proposes embodiments in which the dynamic clamping force component is maximized by using clamping bodies of the highest possible spatial density (for example of lead) and radial extension. By this means, the initial clamping force to be exerted by the pre-clamping element can be reduced and nevertheless during dressing, in which the mandrel is in rapid rotation of usually several thousand to tens of thousands of rotations per minute, a secure and displacement-resistant grip is guaranteed. With a radial extension of 1 cm, a spatial density of 11 gram per cubic centimetres and an average radius of 1.5 cm, a clamping pressure of about 6500 hectopascals or 6.5 bar at 6000 rpm, 26 bar at 12,000 rpm and 104 bar at 24,000 rpm is produced.

This clamping pressure can be further increased if the average radius, that is to say the average distance of the clamping bodies from the axis of rotation is increased. This could be performed while retaining the positioning of the clamping body below the hydraulic medium chamber simply by increasing the general shaft dimensions. This is limited by the predetermined size of the through-opening of the circular tools to be dressed, the diameter of which is usually between about 50 and 70 mm. Likewise, although a dynamic pressure increase takes place in the hydraulic medium due to the rotation, this is generally negligible because of the low density of known hydraulic fluids—for example an order of magnitude lower than that of the clamping bodies. Alternatively or additionally, the present invention therefore proposes disposing the clamping body above the hydraulic chamber in the radial direction. The clamping bodies here can either be held so as to be radially displaceable such that, on clamping in of a circular tool, the top side of the clamping bodies projects beyond the surrounding shaft surface, that is to say that the clamping face of the clamping section is formed only by this/these clamping body top side(s). However, this would have the disadvantage that the clamping force does not act uniformly on the circular tool, in any event when partition walls are present for the above-mentioned circumferential subdivision. This disadvantage can be resolved either by not using partition walls or by providing an elastic layer that covers the clamping bodies, the surface of this layer forming the clamping face.

The hydraulic pressure in the hydraulic chamber can either be directly transferred to the clamping bodies in that the underside of the clamping body forms the ceiling of the hydraulic chamber. In this case, the pressure-tightness between the chamber and the movement space of the clamping bodies is ensured by a suitable surrounding seal, which, however, in any event is exerted by means of a radial frictional force on the clamping body. The clamping force transmitted by the clamping bodies would be reduced by this frictional force. Dressing mandrels according to the invention can, in other embodiments, also provide a permeable material layer, which ensures sealing, between the hydraulic medium chamber and the clamping body. So that it transmits the pressure of the hydraulic medium as far as possible to the clamping body, this layer must be made as thin, and therefore elastic, as possible.

A considerable advantage of the use of this dynamic gripping effect, in addition to a static (pre-)clamping thus lies in the fact that the clamping force increases with the square of the rotational speed and thus the tool is all the more firmly clamped on the mandrel, the higher the rotational speed is during machining. The preclamping can thus be reduced to a necessary minimum for precise positioning and the difference from the clamping force necessary during dressing for a reliable fastening can be provided by means of the dynamic gripping tension.

A simple but nevertheless very effective realization of a preclamping element for the dressing mandrel according to the invention is a clamping screw which is screwed into a bore, which is in fluid communication with the hydraulic chamber. The bore can be introduced laterally, that is to say in the collar of the shaft and run radially or at least essentially radially, or else be introduced at a different point, for example at an end face of the shaft or another accessible point. Screwing in or screwing out of the clamping screw herein effects a reduction or increase in size of the volume available to the hydraulic medium, the pressure of the medium being adjustable. In the event of a pressure increase, the clamping section bulges radially outward and/or increases the gripping force exerted on a clamped circular tool. In the case of a pressure reduction, a bulging of the clamping section is conversely reversed or reduced by virtue of its elasticity and/or the gripping force exerted on a circular tool is reduced.

For precise axial positioning, the shaft, in some embodiments of the dressing mandrel according to the invention, may have an abutment shoulder. A tool to be dressed is, during mounting, pushed on until it bears by at least a portion of its end faces areally against the abutment shoulder. Its axial position is thus fixed and also secured, at least against forces acting in an axial orientation.

If the circular tool is to be completely axially fixed, the present invention proposes providing a fixing disk, which is mounted on the shaft of the dressing mandrel after the circular tool and is here fixed in a suitable manner. One possibility would be securing by means of a splint. However, this is difficult in practice because of the high rotational speeds. Another possibility is to provide the opening, which is necessarily present, of the fixing disk with an internal thread and to provide the shaft with a corresponding external thread in the front region, which, seen from the tool, is located on the other side of the abutment shoulder. The fixing disk could thereby simply be screwed on. However, the disadvantage of this is that the dressing mandrel, without further securing measures, can only be securely operated in one direction of rotation, namely counter to the direction of turn of the thread.

If an abutment shoulder and a fixing means in the form of a fixing disk is used, the present invention further proposes combining the axial fixing with a radial preclamping, alternatively or additionally to a further clamping element. For this purpose, at least two possibilities are available.

First, the cross-section of the shaft in the region of the threaded section, may deviate from a circular form by the fact that, for example, an elliptical or oval form is chosen or one or more thickenings around the circumference are provided. The hydraulic medium chamber is then designed such that, at least in the regions of the threaded section, in which, by virtue of the shape, the radius is increased beyond the mean into this region and thereby extends below these elevations. These offshoots of the chamber should extend below the surface of the shaft as closely as possible, however without jeopardizing the stability and tightness. The deformation of the threaded section exerted on screwing on of the fixing disk is thereby converted as effectively as possible into a volume or pressure change in the hydraulic medium chamber.

In this context, it is further recommended, in order to facilitate precise screwing on and to ensure a stepwise increase of pressure and therefore of preclamping force, that the average shaft diameter be designed such that it increases starting from that end of the shaft that faces away from the abutment shoulder as far as the abutment shoulder or as far as the end of the threaded section. A possible and expedient implementation of this idea is a linear increase of an average diameter some per mille to percent smaller than the diameter of the generally preferably circular opening of the fixing disk as far as an end value that approximately corresponds to that of the fixing disk opening.

Another possibility for connecting the axial fixing to the (setting of the) radial preclamping is to provide in that end face of the abutment shoulder that faces the circular tool one or more in particular rotationally symmetrically disposed force-transmission elements, which transfer the axial gripping force exerted on the abutment shoulder by the fixing disk, via the circular tool, into the hydraulic medium chamber. To this end, the chamber is designed such that it extends, at least in offshoots into the abutment shoulders and closely below the pressure-transfer elements.

As force transmission element, pins can be used, which are inserted into bores, which extend into the (offshoots of the) hydraulic medium chamber. Such pins must be adequately sealed to prevent leaking of the hydraulic medium. To ensure sealing under all circumstances, bores can be dispensed with and the force transmission elements can be designed as pins that project beyond the rest of the surface of the abutment shoulder end face.

Further properties and features of the present invention result from the figures of exemplary embodiments that are described in detail below. These are only intended to illustrate the invention, and in no way to limit it, wherein:

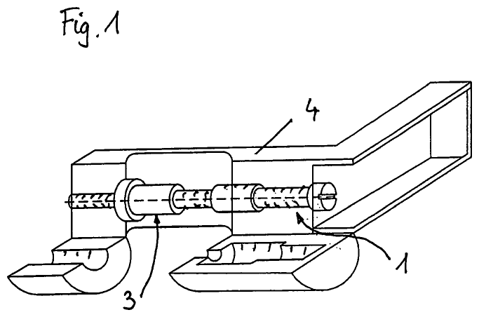

FIG. 1 shows a perspective view of an embodiment of a dressing machine according to the invention with an inserted dressing mandrel

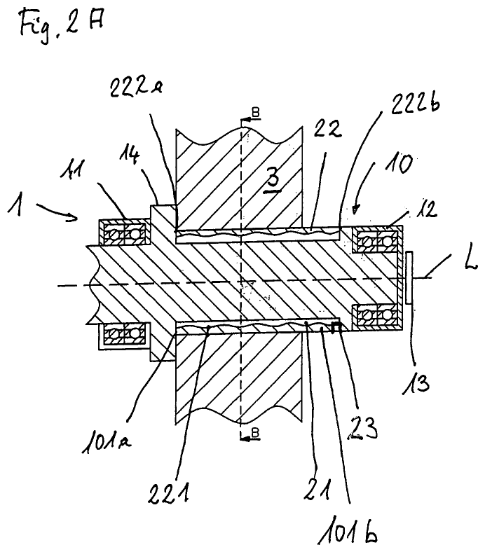

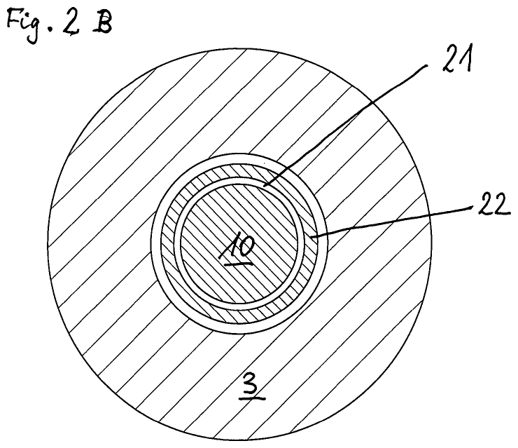

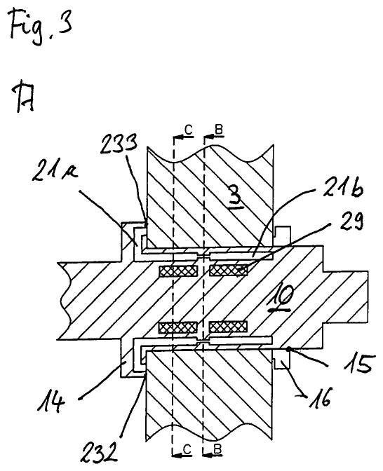

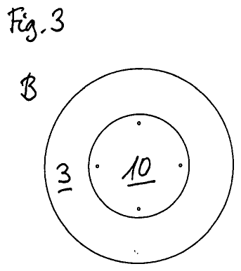

FIG. 2 shows a dressing mandrel of a dressing machine according to a first preferred embodiment in longitudinal and cross section

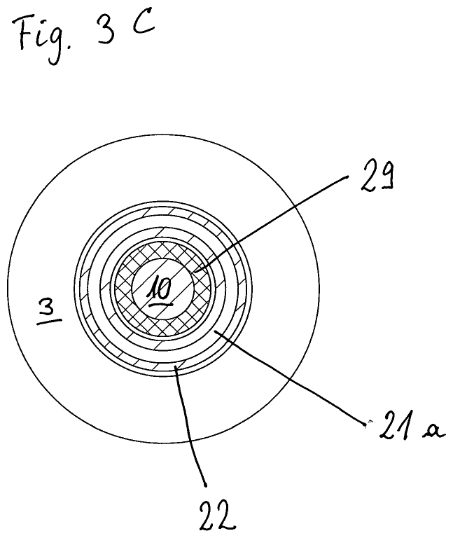

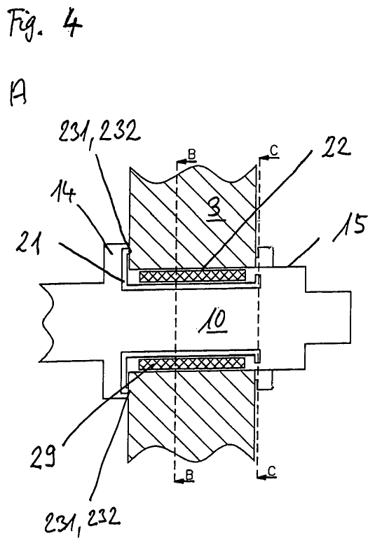

FIG. 3 shows a dressing mandrel of a dressing machine according to a second preferred embodiment in longitudinal as well as two cross sections.

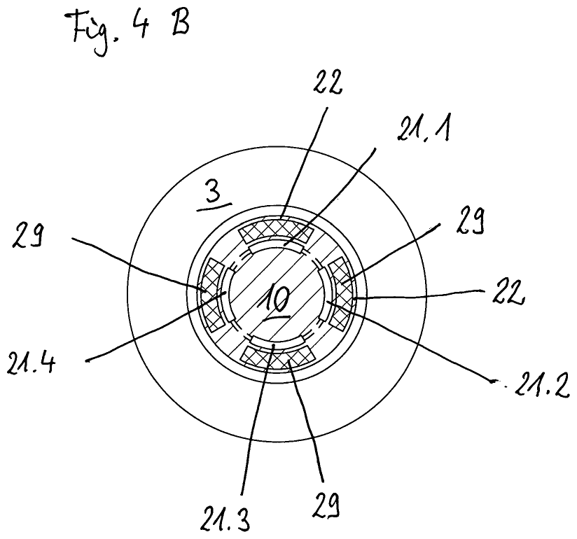

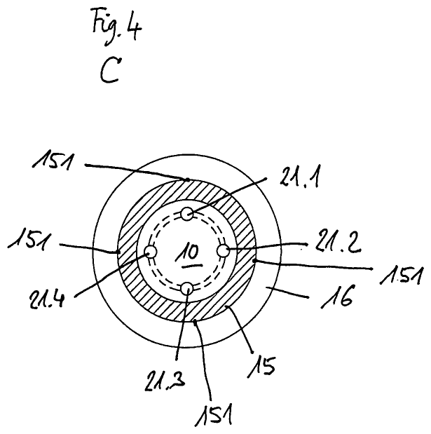

FIG. 4 shows a dressing mandrel of a dressing machine according to a third preferred embodiment in longitudinal as well as two cross sections

FIG. 1 shows a possible embodiment of a dressing device according to the invention. This housing 4, which consists of two foldable halves, into which the dressing mandrel 1 is inserted and, after folding closed and securing of the housing halves, is held and fixed on bearings 11 and 12 disposed on both sides of the shaft 10. A circular tool in the form of a profiled grinding disk 3 is shown clamped on the dressing mandrel 1. For rapid exchange of the tool, the half shells are articulated at their lower edge and are connected at their upper edge by means of an interlocking mechanism that can be actuated without tools.

FIG. 2 shows the dressing mandrel of a dressing machine according to the invention in a preferred embodiment.

Partial figure A shows a longitudinal section in a plane containing the axis of rotation L, while partial figure B shows a cross-section along the line BB.

The dressing mandrel 1 comprises shaft 10 with the abutment shoulder 14, which serves for axial positioning, as well as two bearings, which are disposed on both sides of the shaft 10, a first bearing 11 and a second bearing 12, which serve for fixing the shaft in a housing of the dressing machine according to the invention, for example according to that shown in FIG. 1. The bearings 11, 12 are presented here as roller bearings, however other bearing types, for example (pneumatic) plain or magnetic bearings can also be used within the scope of the present invention. On the end face of the outer bearing sleeve of the second bearing 12, sensor 13 is positioned, which may be in particular an acoustic sensor and, in a manner familiar in the prior art, serves for monitoring and determining the (operating) state and the correct function of the machine. The shaft 10 of dressing mandrel 1 in turn comprises the clamping device 2, consisting of the elastic clamping section 22, (hydraulic medium) chamber 21, which lies radially below said clamping section and is filled with a pressurized hydraulic medium and the preclamping element 23 for setting the hydraulic chamber pressure. The outer and clamping face of clamping section 22 has the form of a cylindrical surface, while the inner surface has the supporting structures 221, which can be seen in the longitudinal section (partial figure A). These supporting structures serve to increase the stability of the clamping section 22 with respect to the effect of radially directed forces, which exceed the hydraulic chamber pressure locally or else over a larger range, as a result of which damage of the clamping device 2 may be threatened. The clamping section 22 is offset inwardly at both ends, the cylindrical springs 222a and 222b being inserted into complementary grooves or notches 101a and 101b of the shaft 10. As a result the clamping section 22 is securely and firmly held in the shaft. Furthermore, the leak-tightness of the shaft-clamping section connection against leaking out of the pressurized hydraulic medium is thereby ensured.

The preclamping element 23 for setting the static hydraulic chamber pressure consists of a screw 233 which is inserted as displacer into a radial bore in the side of the shaft 10. This bore leads into the the hydraulic chamber, which, at least at this place, extends beyond the clamping section, or into an offshoot of the chamber. Further screwing in or screwing out again of screw 233 changes the effective volume of the hydraulic chamber and therefore also the pressure of the medium therein. Thus, the desired (static) preclamping can be set as desired: if a circular tool is mounted or removed, the screw 233 is rotated out to such an extent that the outer diameter of the clamping section 22 is smaller than the opening of the tool or no significant clamping is exerted on the tool. The tool can now be mounted or taken off. In contrast to the thermal shrinking or expansion used in the prior art, which takes many hours and is associated with a high risk of damaging both the tool and the dressing mandrel, the process with the mandrel according to the invention only takes several to several tens of seconds at most. This is a time gain that can hardly be overestimated in practice. The disadvantage at which it is bought is the design-dependent higher elasticity of the dressing mandrel: the thin-walled and correspondingly elastic clamping section and the hydraulic medium generally have higher elasticity than a solid shaft. This is expressed as increased vibration and a reduced true-running and axial run-out under non-uniformly acting forces. The supporting structures 221 present in the embodiment according to FIG. 2 on the inside of the clamping section can only compensate for this to the extent that the amplitude of the vibrations is larger than the distance of the structures from the base of the hydraulic chamber 21. An operational possibility for reducing these vibrations is to note, during dressing of the circular tool, that as far as possible, only uniform, that is to say mutually compensating forces are exerted on the tool and therefore on the dressing mandrel. However, if increased stability by design, that is to say reduced elasticity, is required, a circumferential and/or axial subdivision is proposed by the present invention, as are shown in the embodiments according to FIG. 3 or 4.

FIG. 3 shows a dressing mandrel with clamping bodies of a dressing machine according to the invention according to another preferred embodiment.

Partial figure A shows a longitudinal section, while partial figures B and C show a cross-section along the lines BB and CC in each case from partial figure A.

The dressing mandrel 1 comprises a shaft 10, which in turn comprises, at one end, a region 15 having an external thread for screwing on an axial fixing disk 16 and at an opposite end an abutment shoulder 14, as well as, between them, a clamping region having a clamping device 2. Likewise, the dressing mandrel, which is not shown here, comprises at least one bearing, preferably two bearings disposed on both sides of the shaft 10, as well as a sensor as shown in FIG. 2. A circular tool in the form of a grinding disk 3 is mounted on shaft 10 or the clamping device 2.

Clamping device 2 comprises a hydraulic medium chamber, which is subdivided into an upper chamber 21a and a lower chamber 21b, which are located below the thin-walled clamping section 22, clamping section 22 being in turn integrally connected to the rest of the shaft 10 at both sides. Thereby, the force transmission into the shaft on one hand and the tightness against leaking out of the pressurized hydraulic medium on the other hand is improved compared to the embodiment in FIG. 2. In a cavity which is radially below the upper and lower hydraulic chambers 21a, 21b, which is [separated?] from them by a thin elastic material layer having a thickness comparable to that of the clamping section 22, radially displaceable clamping bodies 29 are present. They have a highest possible spatial density and radial extension in order to achieve a high areal density. Due to the centrifugal forces acting thereby on the clamping bodies during rotation of the dressing mandrel, the pressure of the hydraulic medium is dynamically increased and thereby the clamping force exerted statically on the tool 3 by virtue of the clamping device 2 is reinforced. The radial extension of the clamping bodies 29, however, is limited because of the necessary stability of the shaft 10.

In the embodiment according to FIG. 3, a two-part hydraulic chamber is used in which, as can be seen in partial figure B, an upper (sub)chamber 21a, which faces the abutment shoulder 14 and a lower chamber 21b are separated from one another by a solid partition wall, with the exception of certain passages for pressure equalization. The partition wall increases the stability of the shaft 10 and thereby the dressing mandrel against external acting forces. In addition to the axial subdivision, a circumferential subdivision into subchambers, as represented in FIG. 4, could also be provided in order to further increase the torsional and bending stiffness of the shaft.

Shaft 10 has an abutment shoulder 14, which interacts with the fixing disk 16, which is screwed onto the threaded section 15 of the shaft, in order to position and fix the tool 3 in an axial direction. The preclamping element 23 which serves for setting the hydraulic medium pressure is, in this embodiment, realised in that diametrically opposing force transmission elements, in the form of projections 233 in that end face of the abutment shoulder which faces the tool are present and the hydraulic chamber extends at least in offshoots as far as closely below these projections, so that that region of the abutment shoulder that bears the projections yields flexibly with the action of an axial force and thereby reduces the effective volume of the hydraulic chamber. If a circular tool is mounted and axially fixed by mean of screwing on the fixing disk, the axial force exerted by means of the fixing disk is transferred via the circular tool to the projections, which yield elastically and thus reduce the volume of the hydraulic chamber, thereby increasing the static pressure of the hydraulic medium. Additionally to or alternative to this type of preclamping generation, however, a further preclamping element, as used in the clamping screw shown in FIG. 2, could also be used.

FIG. 4 shows a dressing mandrel of a dressing machine according to the invention, according to a third preferred embodiment with clamping bodies radially above the hydraulic chamber.

Partial figure A again shows a longitudinal section while partial figures B and C in each case show a cross-section along the lines BB and CC from partial figure A.

In partial figure A as well as partial figure B, it can be seen that in this embodiment according to the invention, the clamping bodies 29, numbering 4 in total, are disposed above the hydraulic chamber. This serves to increase the distance of the clamping body from the axis of rotation of the dressing mandrel and thereby increase the above-described dynamic clamping effect. The clamping section 22, which is located above the clamping body and of which the outer surface represents the clamping face, is made as thin as possible in order to achieve a high elasticity. This is possible since bending forces acting on the shaft can be absorbed and dissipated by means of the separation sections located between the clamping bodies as well as by means of the clamping bodies. This is possible since the clamping bodies 29, in comparison to the chambers filled with hydraulic medium, which, in the other embodiments shown according to FIGS. 2 and 3, occupy the space that is held by the clamping bodies 29 here, have a significantly higher modulus of elasticity and are dimensionally stable as solid bodies. The clamping bodies 29 in this embodiment have a circular ring segment-shaped cross-section and have a certain radial movement tolerance such that they can effect a clear bulging of the clamping section 22. To achieve guidance of the clamping bodies that is as far as possible free of axial and tangential backlash, and still ensure freedom of the radial movement, a lubricant can be introduced into the cavities that are accommodated in the clamping bodies 29. Alternatively, a roller bearing can also be used.

The hydraulic chamber is subdivided into four circumferential, rotationally symmetrical subchambers 21.1 to 21.4, which for purposes of pressure equalization are in fluid communication via channels and of which each is assigned to one of the four clamping bodies, namely disposed directly below (see partial figure B). The chamber cross-section can, like that of clamping body 29, correspond to a circular ring segment or else be otherwise designed, with the only provision that the separating cover separating the chamber and the clamping body cavities is sufficiently thin and elastic in order to achieve a corresponding deformation and therefore radial displacement of the clamping body in the event of pressure change in the hydraulic medium chamber. In addition, to increase the resistance force, an axial subdivision of the chambers as in the embodiment according to FIG. 3 could be provided.

Partial figure C shows a cross-section through the shaft 10 in the region of the thread section 15, in which the fixing disk 16 is located, which, in interplay with the abutment shoulder, positions and fixes the tool 3 in the axial direction. As illustrated, the cross-section of the shaft here departs significantly from a circle: above each of the hydraulic (sub)chambers 21.1-21.4, there is a bulge 151. This is dimensioned such that the radius of the shaft, at the highest point of the bulge, is a little larger than the clear radius of the opening of the fixing disk 16. Since the chamber here, in a similar way to the clamping section, extends below the surface of the shaft, the shaft has a certain elasticity in these bulges 151. During screwing on of the disk, the curvatures are pressed inwardly and the volume of the hydraulic chamber is thus reduced and the pressure of the medium contained therein is correspondingly increased. To achieve a gradual increase of the pressure during screwing on of the disk, the threaded region 15 of the shaft 10 is designed such that its radius gradually increases from the end facing the abutment shoulder. This variation must be adapted to the compliance of the bulges; however will not exceed several percent in general.

Although this setting of the preclamping could basically be sufficient, force transmission elements are disposed in that end face of the abutment shoulder 14 that faces the tool 3, as additional elements for generating or increasing the static preclamping in a similar way to that shown in FIG. 3. Other than there, however, they consist of bores 231, which extend as far as into the hydraulic chambers 21.1 to 21.4, into which radially displaceable pins 232 are inserted.

Since the above-described geometry of the threaded section 15 effects a firm relationship between the number of screwed-on rotations of the fixing disk and the (radial) preclamping, it could be that for thin tools, a maximum preclamping is achieved before it is sufficiently axially fixed. It order to be able to compensate for this, a third element, which is not shown here, for setting the static hydraulic medium pressure and thus the preclamping could be provided, for example a clamping screw as in the embodiment in FIG. 2.

### LIST OF REFERENCE CHARACTERS

1 Dressing mandrel
10 Shaft
11 First bearing
12 Second bearing
14 Abutment shoulder
15 Thread section
151 Protrusion
16 Fixing disk
2 Clamping device
21 Hydraulic medium chamber
21.1-4 Circumferential subchambers
21a, 21b Lower, upper subchambers
22 Clamping section
23 Clamping element
231 Bore to receive 232
232 Pin
233 Projection
29 Clamping body
292 Outer surface
3 Tool, grinding disk
4 Housing
L Longitudinal and rotational axis of the dressing mandrel

The invention claimed is:

1. Dressing device, comprising:
a housing (4), and
a dressing mandrel (1) having a shaft (10), which serves for the mounting of a circular tool with a through-passing concentric opening, in particular a grinding disk (3), and a first bearing (11), which is fixed on the housing (4) and is located in a first end region of the dressing mandrel (1), and
a dressing tool for dressing the circular tool which is mounted on the dressing mandrel (1),
the shaft (10) having a hydraulic clamping device (2), which extends through the opening in the circular tool and comprises a chamber (21) with a hydraulic medium, which can be subjected to a preclamping pressure by means of a preclamping element (23),
the hydraulic clamping device being formed from a clamping section (22), which is held in the shaft at both sides and, in a radial direction, is located above the chamber (21) and of which the outer surface forms the clamping face and which bulges outwardly in a radial direction on an increase of the hydraulic pressure in the chamber (21), such that a radial clamping force is exerted on the inner surface of the concentric opening of the circular tool, through which the clamping section (22) passes.

2. Dressing device according to claim 1, wherein the dressing tool is a diamond roll.

3. Dressing device according to claim 1, wherein the clamping section (22) is at least partly designed as a sufficiently thin, hollow-cylindrical material cover that is integral with the shaft (10).

4. Dressing device according to claim 1, wherein the chamber (21) is circumferentially subdivided into a plurality of congruent subchambers (21.1-4), which are disposed rotationally symmetrically about a longitudinal axis (L) of the shaft (10).

5. Dressing device according to claim 1, wherein a plurality of chambers (21a, 21b) are present along the shaft (10).

6. Dressing device according to claim 1, further comprising a second bearing (12) of the dressing mandrel (1), which is disposed in particular on that side of the clamping device (20) that is opposite the first bearing (11).

7. Dressing device according to claim 1, wherein the clamping section (22) comprises two or more clamping bodies (29), which are held such that they are displaceable in the radial direction as far as a stop.

8. Dressing device according to claim 7, wherein the clamping bodies (29) are disposed in the radial direction below the chamber (21), the stop being formed by the underside of the base (211), which separates the underside of the chamber (21) from the movement space of the clamping body/bodies or by those sides, lying opposite the clamping bodies, of the space that contains the clamping bodies and the outer surface (292) of the clamping bodies projects into the hydraulic chamber (21) such that the outer surfaces are in direct contact with the hydraulic medium.

9. Dressing device according to claim 7, wherein the clamping bodies (29′) are disposed in a radial direction above the chamber (21) and are entirely disposed below the clamping section (22) or the clamping section (22) is penetrated such that at least a portion of the clamping face is formed by the outer surface of the clamping bodies (29), the stop being formed by at least two opposing end sides of the clamping bodies (29) and, on reaching the stop, the outer surface (292) of the clamping bodies (29) projects beyond the surrounding surface of the shaft (10).

10. Dressing device according to claim 1, wherein the preclamping element (23) is a clamping screw, which is screwed into a threaded bore (24) of the shaft, which is in fluid communication with the chamber (21).

11. Dressing device according to claim 1, wherein an abutment shoulder (14) of the shaft (10), which serves for axial positioning of the circular tool.

12. Dressing device according to according to claim 11, further comprising a fixing disk (16), which, in connection with said abutment shoulder (14), serves for axial fixing of the circular tool, and can be screwed onto a screw thread (15) of the shaft (10).

13. Dressing device according to claim 12, wherein the preclamping element (23) is formed by the fact that
at least that section of the shaft (10) that bears the screw thread (15) deviates at least partially along its axial extension from a circular cross-section, in particular having an oval or elliptical form, the difference between a maximum and a minimum radius being several per mille to percent, and an average radius corresponding to approximately the radius of a passable opening (150) of the fixing disk (15) having an internal thread, and
the chamber (21) extending to below that section of the shaft (10) that bears the thread (15).

14. Dressing device according to claim 11, wherein the preclamping element (23) is formed by the fact that
in an end face of the abutment shoulder (14) which faces the circular tool, there is at least one force transmission element,
the chamber (21) extends into the abutment shoulder (14) and as far as below the force transmission element, and
the force transmission element being a pin (231), which is inserted into a bore (230) extending into the chamber (21) or a projection (232) integrally formed on the surface of the abutment shoulder (14).

15. Method for mounting a circular tool having a concentric opening on a dressing mandrel of a dressing device according to claim 1, comprising:
a) in a first step, if appropriate, the fixation of the dressing mandrel in the housing of the dressing device is released at at least one side,
b) in a subsequent second step, if appropriate, an axial fixation and positioning means, which is independent of the preclamping element, such as a fixing disk (16) is released from the shaft and removed,
c) then in a third step, by means of the preclamping element the pressure of the hydraulic medium and thus the external diameter of the clamping section is reduced to such an extent that it is at least slightly smaller than the clear width of the opening of the circular tool,
d) in a subsequent fourth step, this is pushed onto the shaft,
e) in a subsequent fifth step by means of the preclamping element, the hydraulic medium in the chamber (21) is subjected to a desired preclamping pressure,
f) then, if appropriate, in a sixth step, an axial fixing means which is independent of the preclamping element, for example a fixing disk (16) is mounted and fastened, and
g) if appropriate, in a subsequent seventh step, the free end of the dressing mandrel is again fixed in the housing (4) of the dressing device.

16. Method for removing a circular tool fastened on a dressing mandrel of a dressing device according to claim 1, comprising:
a) in a first step, if appropriate, the fixation of the dressing mandrel in the housing of the dressing device is released at at least one side,
b) in a subsequent second step, if appropriate, a fixation means, which is independent of the preclamping element (23), such as a fixing disk (16) is released and removed,
c) then in a third step the preclamping element is brought into a relaxation position and the hydraulic pressure in the chamber (21) and thereby the preclamping force acting on the circular tool is reduced until it can be pulled off the shaft, and
d) in a subsequent third step, the tool is pulled off the shaft and removed.
